(19) United States
(12) Patent Application Publication
(10) Pub. No.: US 2008/0250952 A1
(43) Pub. Date: Oct. 16, 2008

(54) SCREEN PRINTING APPARATUS, SCREEN PRINTING METHOD, AND LIQUID CRYSTAL PANEL MANUFACTURED USING THE APPARATUS OR METHOD

(75) Inventors: Takeshi Kubota, Tokyo (JP); Seiichi Kinoshita, Kumamoto (JP); Kouhei Banka, Kumamoto (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 12/100,164

(22) Filed: Apr. 9, 2008

(30) Foreign Application Priority Data
Apr. 10, 2007 (JP) P2007-102627

(51) Int. Cl. B05C 17/08

(52) U.S. Cl. 101/126

(57) ABSTRACT

A screen printing apparatus has: a screen mask having an opening pattern; a squeegee for coating a paste disposed on the screen mask to a plane of a substrate disposed on the lower part of the screen mask via the opening pattern; and a stage for holding the substrate comprising: a stage base; and a height adjusting member disposed or attached to the stage base, the height adjusting member adjusting a relationship between a plane composed of a part of the stage and the height of the plane of the substrate.

### CROSS REFERENCE TO RELATED APPLICATION

The present application claims priority from Japanese Patent Application No. 2007-102627, which was filed on Apr. 10, 2007, the disclosure of which is herein incorporated by reference in its entirety.

### TECHNICAL FIELD

The present invention relates to a screen printing apparatus for forming a seal pattern in manufacturing a liquid crystal panel.

### BACKGROUND

In a manufacturing process for a liquid crystal panel typically as a display device having a cell structure surrounded like a frame by a seal pattern, a panel assembling step includes: coating an oriented film on the surface of each of a switching element substrate mounting a switching element for driving the liquid crystal, which is created mainly from a glass substrate, and a color filter substrate that acts as a color filter; rubbing these substrates; aligning the substrates with a clearance; cutting the panel into a predetermined panel size, and filling liquid crystal into the clearance.

To align the substrates, a seal pattern is formed on a switching element substrate or a color filter substrate in the shape to surround a display portion of the panel. Generally, there are two methods, a screen printing method of extruding the sealing material through an opening portion of the seal pattern formed on the screen mask and a seal dispensing method of drawing a pattern by scanning the nozzle. Of both methods, the screen printing method is widely employed due to excellent productivity even if the number of panels per substrate is large.

In a seal pattern forming process with such screen printing method, the screen mask is pushed against the substrate during printing depending on the printing conditions, so that a mesh pattern on the surface of the screen mask may be transferred onto an oriented film on surface of the substrate in some cases. As a result, a predetermined orientation of liquid crystal with the oriented film can not be obtained in a transferred portion of the mesh pattern, which is thereby visible as an unevenness to cause a display failure of the image on the liquid crystal panel.

As its countermeasure, a patent document 1 disclosed a method in which the printing is performed in a state where a chuck for securing the substrate overhangs out of the surface of the substrate, so that the screen mask makes contact with the overhanging chuck ahead, relieving a pressure with which the screen mask is pushed against the surface of the substrate. [Patent document 1] JP-A-2000-147524

### SUMMARY

However, in a large glass substrate treated through the screen printing process in recent years, the control of the distance between the substrate surface and the screen mask and the applied pressure on the squeegee that pushes the screen mask are highly influential on occurrence of a failure due to transfer of the mesh pattern and a variation in the width of seal pattern. It is required that those factors are fairly controlled at every position on the large substrate surface. However, it was difficult to control a gap between the screen mask and the substrate using the chuck that is a movable part or a stage with definite height independent of the chuck, and impossible to control it stably in mass production, as described in patent document 1.

The invention has been achieved to solve the above-mentioned problems, and it is an object of the invention to provide a screen printing apparatus and a manufacturing method for a liquid crystal panel which can manufacture the liquid crystal panel stably by preventing a display failure due to transfer of the mesh pattern of the screen mask or a variation in the width of a seal pattern when forming the seal pattern by screen printing.

This invention provides a screen printing apparatus for coating a paste on a screen mask via an opening pattern provided on the screen mask to a plane of a substrate disposed on the lower part of the screen mask by running a squeegee, characterized in that a stage for holding the substrate comprises a stage base and a height adjusting member, secured or attached to the stage base, for adjusting the relationship between a plane composed of a part of the stage and the height of the main plane of the substrate.

According to the invention, it is possible to prevent a display failure due to transfer of the mesh pattern of the screen mask in forming the seal pattern by screen printing.

### BRIEF DESCRIPTION OF THE DRAWINGS

Illustrative aspects of the invention will be described in detail with reference to the following figures wherein:

FIG. 1 is a perspective view of a stage for a screen printing apparatus according to a first exemplary embodiment of the present invention;

FIG. 2 is a perspective view of a gap adjusting plate constituting the stage for the screen printing apparatus according to the first exemplary embodiment of the invention;

FIG. 3 is a cross-sectional view of the stage for the screen printing apparatus according to the first exemplary embodiment of the invention;

FIG. 4 is an explanatory view showing a printing operation state of the screen printing apparatus according to the first exemplary embodiment of the invention;

FIG. 5 is an explanatory view showing a printing operation state of the screen printing apparatus according to the first exemplary embodiment of the invention;

FIG. 6 is a perspective view of the stage for the screen printing apparatus according to a second exemplary embodiment of the invention;

FIG. 7 is an explanatory view of the gap adjusting plate constituting the stage for the screen printing apparatus according to the second exemplary embodiment of the invention;

FIG. 8 is an explanatory view of the gap adjusting plate constituting the stage for the screen printing apparatus according to a first modification of a third exemplary embodiment of the invention;

FIG. 9 is an explanatory view of the gap adjusting plate constituting the stage for the screen printing apparatus according to a second modification of the third exemplary embodiment;

FIG. 10 is an explanatory view of the gap adjusting plate constituting the stage for the screen printing apparatus according to a third modification of the third exemplary embodiment of the invention;

FIG. 11 is a cross-sectional view of the stage for the screen printing apparatus according to a fourth exemplary embodiment of the invention;

FIG. 12 is a cross-sectional view of the stage for the screen printing apparatus according to a fifth exemplary embodiment of the invention;

FIG. 13 is plan and side views of the stage for the screen printing apparatus according to the fifth exemplary embodiment of the invention;

FIG. 14 is an explanatory view of the gap adjusting plate constituting the stage for the screen printing apparatus according to the fifth exemplary embodiment of the invention;

FIG. 15 is an explanatory view of the gap adjusting plate constituting the stage for the screen printing apparatus according to a modification of the fifth exemplary embodiment of the invention;

FIG. 16 is a plan view of the stage for the screen printing apparatus according to a sixth exemplary embodiment of the invention;

FIG. 17 is an explanatory view showing an operation state of the stage for the screen printing apparatus according to the sixth exemplary embodiment of the invention;

FIG. 18 is a constitutional view of a liquid crystal panel according to a seventh exemplary embodiment of the invention; and

FIG. 19 is a flowchart showing an assembling process in a manufacturing method for the liquid crystal panel according to the seventh exemplary embodiment of the invention.

### DETAILED DESCRIPTION OF THE PREFERRED EMBODIMENTS

### Embodiment 1

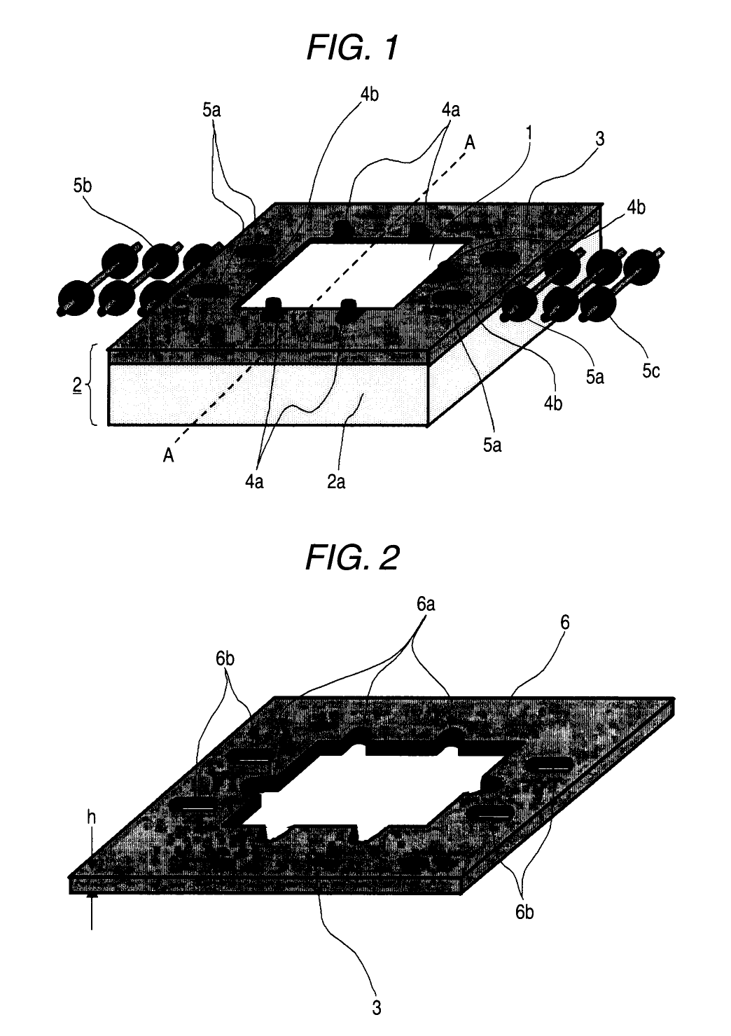

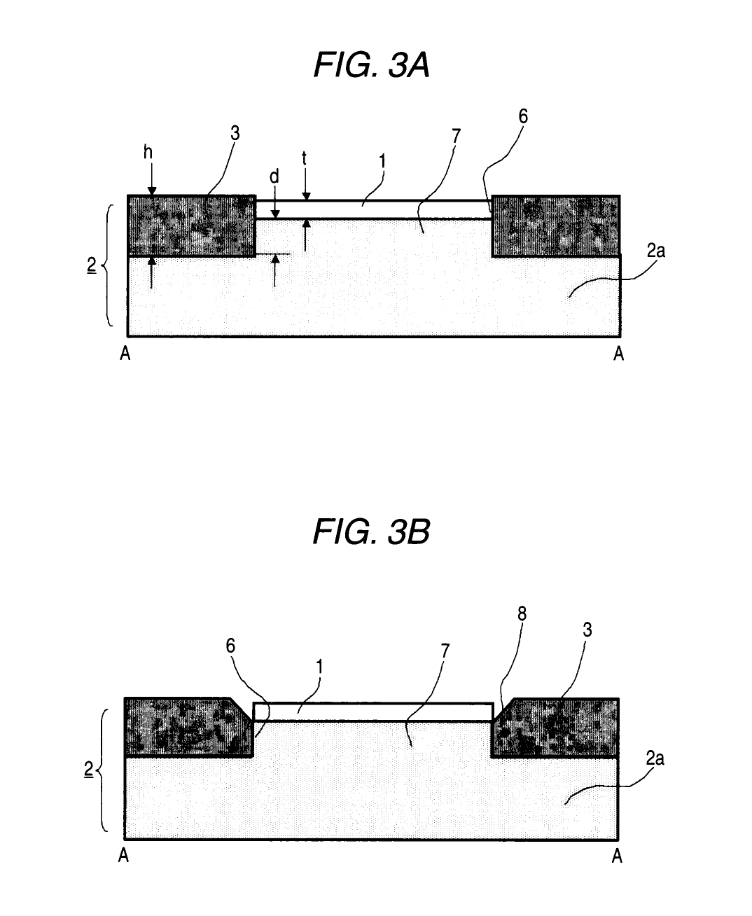

The constitution of a screen printing apparatus according to a first exemplary embodiment (embodiment 1) of the invention will be described below, using FIG. 1 that is a perspective view of a stage, FIG. 2 that is a perspective view of a gap adjusting plate constituting the stage, and FIG. 3 that is an explanatory view of a state where the gap adjusting plate is mounted. These figures are schematic, but do not reflect the accurate sizes of components as shown. In the figures, the same parts as already described in connected with the previous figures are designated by the same reference numerals or signs, and the explanation for the same parts is omitted. The same applies in the following.

A stage 2 holding a substrate 1 constituting this screen printing apparatus comprises a stage base 2a, a gap adjusting plate 3, attached on the stage base 2a, acting as a height adjusting member for adjusting the relationship between the upper surface of the stage 2 and the height of a main plane of the substrate 1, the alignment mechanisms 4a and 4b for positioning the substrate 1, the conveying rollers 5a and 5aa (conveying roller 5aa, not shown, having the same structure as the conveying roller 5a and disposed under the substrate 1 in the figure) for conveying the substrate 1 to the position where it can be positioned on the stage, as shown in FIG. 1. Also, the conveying rollers 5b and 5c for conveying the substrate onto or out of the stage 2 are disposed before and after the stage 2.

As will be apparent from the perspective view of FIG. 2, the gap adjusting plate 3 is annular and formed with a mortise portion 6 in the shape of the substrate, and is a block having a thickness h greater than or equal to the thickness of the substrate 1. Especially if a certain strength or thickness accuracy is provided, there is no problem whether metal or resin is employed, although the stainless material is employed here because it is easy to ensure the thickness accuracy through the cutting work, and possible to secure a required strength. Also, the gap adjusting plate 3 is formed with a mortise portion 6a corresponding to the operation range of the alignment mechanisms 4a and 4b and a mortise portion 6b corresponding to the position of the conveying roller 5a, as needed.

FIG. 3A is a cross-sectional view showing a mounted state of the gap adjusting plate 3, taken along the line A-A in FIG. 1. From FIG. 3A, it can be found that the mortise portion 6 corresponding to the shape of the substrate is fitted with a protruding portion 7 with a convex face holding the substrate 1 formed on the stage base 2a. The dimensional accuracy of assembling is preferably as high as the substrate is easily removable and no deviation or looseness occurs. Also, the gap adjusting plate 3 has a certain thickness and weight and can be fitted and attached in the above way, particularly without fixture such as screw, whereby the printing can be made precisely. Also, since the gap adjusting plate 3 is formed of stainless or the like in a thickness greater than or equal to the thickness of the substrate 1, there is less deformation and the durability is excellent even if it is repeatedly attached or detached on or from the stage base 2a.

Also, the corresponding gap adjusting plate 3 is prepared according to the thickness of the substrate 1 to be treated, and properly used, whereby the adequate printed result can be easily obtained. For example, the height d of the protruding portion 7 is a fixed value in the initial design of the printing apparatus, in which if the substrate 1 possibly treated by this apparatus has three kinds of substrate thickness, t1, t2 and t3, three kinds of gap adjusting plates 3 having different thicknesses, such as a gap adjusting plate 3a of the thickness h=h1 satisfying 0.1 mm≦h1−d−t1≦0.2 mm, a gap adjusting plate 3b of the thickness h=h2 satisfying 0.1 mm≦h2−d−t2≦0.2 mm and a gap adjusting plate 3c of the thickness h=h3 satisfying 0.1 mm≦h3−d−t3≦0.2 mm, are prepared and exchanged according to the kind of the substrate 1, as shown in FIG. 3A.

Subsequently, FIG. 3B is a cross-sectional view, like FIG. 3A, in which the shape of the gap adjusting plate 3 of FIG. 3A is slightly changed. As can be seen from FIG. 3B, a chamfer 8 is obliquely formed on the corner of the mortise portion 6 of the gap adjusting plate 3.

By attaching the gap adjusting plate 3 with this chamfer 8 on the upper side thereof, an opening portion of the mortise portion 6 of the gap adjusting plate 3 receiving the substrate 1 is spread upward. With this structure, the substrate 1 conveyed on the stage 2 is positioned to this spread opening portion, guided along the surface of the chamfer 8, and positioned at a predetermined position on the protruding portion 7 of the stage base 2a to hold the substrate 1. As a result, the positioning accuracy of the substrate 1 with the alignment mechanism 4a can have a wider permissible range. Further, the accuracy of the conveying roller 5a is improved, or the substrate is aligned in the width direction of substrate during conveyance, and conveyed into the opening portion spread by the chamfer 8, whereby the alignment mechanism 4a can be dispensed with.

Referring to FIG. 1, the operation of the stage 2 in the screen printing apparatus according to the embodiment 1 will be described below. First of all, the substrate 1 is conveyed up to the position on the stage 2 where it can be positioned the conveying rollers 5b, 5a and 5aa as described in connection with FIG. 1. Next, the alignment mechanisms 4a and 4b performs an operation of sandwiching the substrate 1 between them to press the ends of the substrate 1 and position it. The alignment mechanism 4a makes the positioning of the substrate 1 in a width direction thereof, and the alignment mechanism 4b makes the positioning of the substrate 1 in a lengthwise direction thereof. Through such a positioning operation, the substrate 1 is received within the mortise portion 6 of the gap adjusting plate 3 attached on the upper surface of the stage 2.

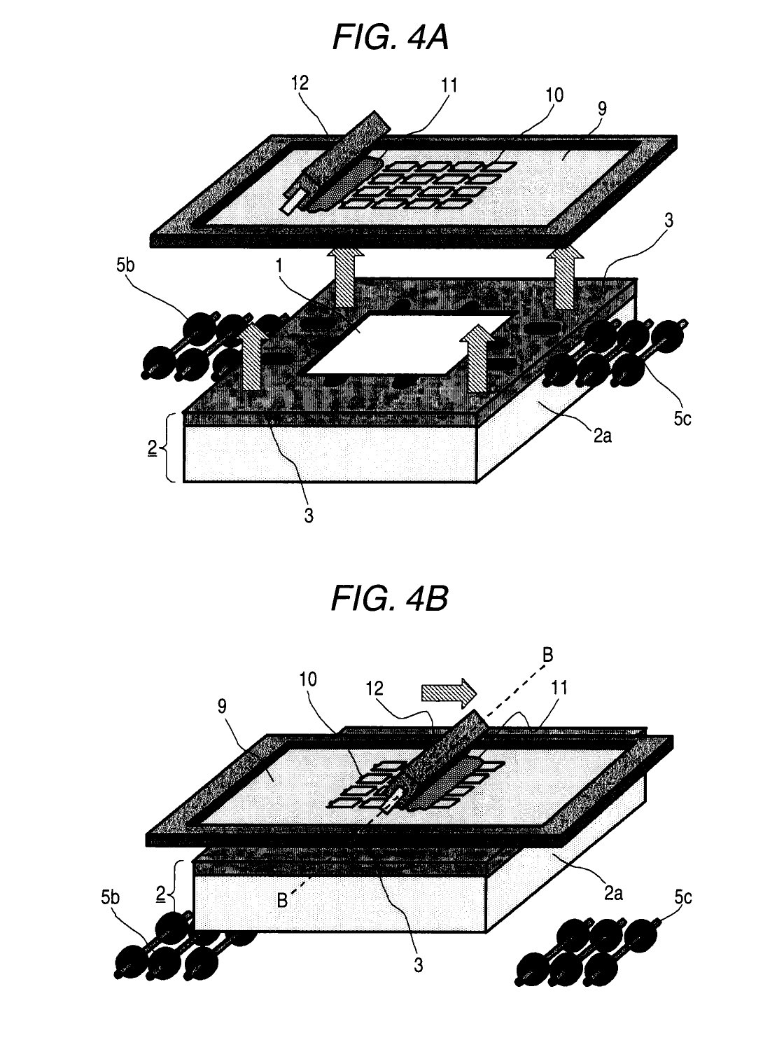

Referring to FIG. 4, the constitution and operation of the parts with the printing of the screen printing apparatus according to the embodiment 1 will be described below. Referring firstly to FIG. 4A, the constitution will be described. Reference numeral 9 denotes a screen mask, reference numeral 10 denotes an opening pattern provided on the screen mask 9, reference numeral 11 denotes a paste coated as a seal pattern on the substrate 1 via the opening pattern 10, and reference numeral 12 denotes a squeegee for running over the screen mask 9 to extrude and print or coat the paste 11 on the substrate 1 through the opening pattern 10.

Next, referring to FIG. 4B, the printing operation will be described. After the positioning operation as described in connection with FIG. 1, the stage 2 rises in a direction as indicated by the arrow in FIG. 4A so that the screen mask 9 and the substrate 1 are closely placed just before contact as shown in FIG. 4B. The printing operation is performed by running the squeegee 12 over the screen mask 9 in the direction of the arrow as indicated in the figure and coating the paste 11 through the opening pattern 10 provided on the screen mask 9 on the main plane of the substrate 1 disposed on the lower part of the screen mask 9, as shown in FIG. 4B.

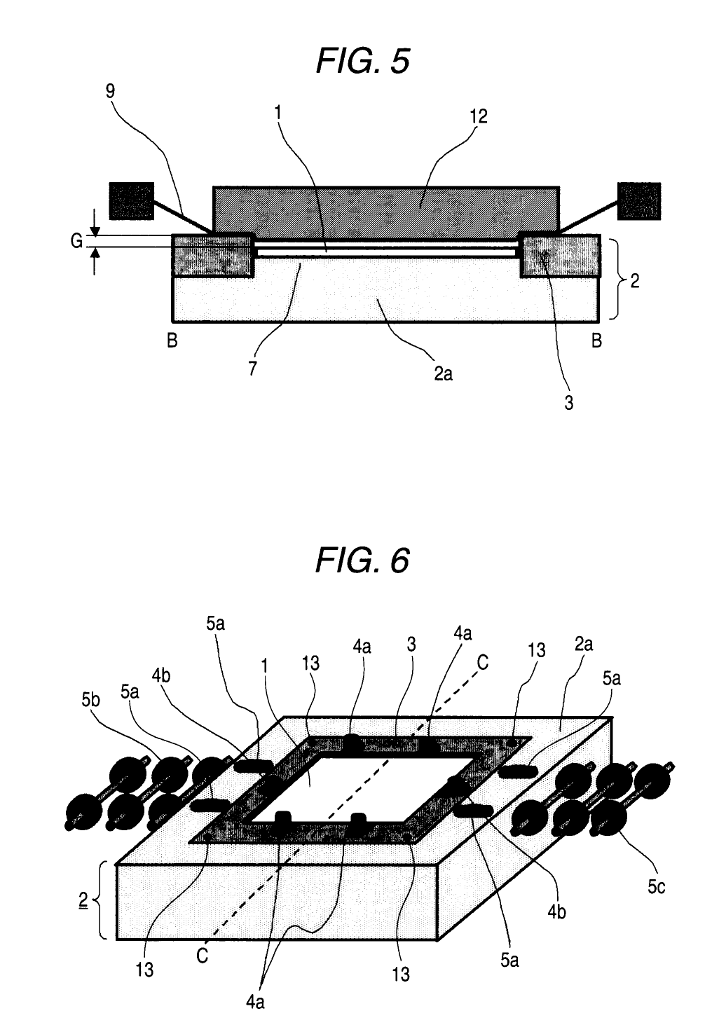

Referring to FIG. 5, the action of a printing process with the screen printing apparatus according to the embodiment 1 will be described below. FIG. 5 is a cross-sectional view taken along the line B-B in FIG. 4B, namely, in the direction vertical to the running direction for the squeegee 12. An upper surface of the height adjusting plate 3 overhangs out of the main plane or upper surface of the substrate 1 on both sides of the substrate 1 in the running direction of the squeegee 12, as shown in FIG. 5. This overhung plane contacts the squeegee 12 via the screen mask 9 and takes a pushing pressure from the squeegee 12 to the screen mask 9. Also, a height difference G (as shown in FIG. 5) between this plane and the upper surface of the substrate 1 is provided. This height difference G acts to make it difficult for the screen mask 9 pushed by the squeegee 12 and overhanging in the direction of the substrate 1 to make contact with the substrate 1, or to reduce a contact pressure on contact. In FIG. 5, the screen mask 9 does not contact the substrate 1.

If the screen mask 9 is strongly pushed against the main plane of the substrate 1, a mesh pattern on the surface of the screen mask 9 is strongly transferred onto an oriented film on the main plane of the substrate 1, causing a display failure. Therefore, it is preferable that the height difference G is positive, and further as large as possible, because the screen mask 9 is more difficult to contact the substrate 1 or the contact pressure on contact is reduced to prevent a display failure. However, in the embodiment 1, the height difference G is selected such that 0.1 mm≦G≦0.2 mm, namely, 0.1 mm≦h−d−t≦0.2 mm, the height difference G is represented as G=h−d−t, where the thickness of the substrate 1 is t, the height of the protruding portion 7 is d, and the thickness of the gap adjusting plate 3 is h.

In addition to the range capable of preventing display failure, the proper range for stabilizing the print seal width with less variation is selected. For stabilizing the print seal width, it is required that a tension for peeling the screen mask 9 from the main plane of the substrate 1 immediately after the squeegee 12 passes through is stably applied. For example, in producing a liquid crystal panel by screen printing, where the size of the standard screen mask 9 is about 1000 mm on one side and the substrate size is about 500 mm in substrate width, if the height difference G is below 0.1 mm, the tension is smaller, so that the screen is not peeled at constant speed. Also, if the height difference G is greater than 0.2 mm, the distance between the main plane of the substrate 1 and the screen mask 9 is too large, causing the paste 10 to smear, or if the applied pressure on the squeegee 12 is unreasonably increased, an elongation of the screen mask 9 occurs. In either case, the stable printing can not be performed as a result.

As described above, in the embodiment 1, if the gap adjusting plate 3 is prepared to satisfy 0.1 mm≦h−d−t≦0.2 mm for the thickness h of the gap adjusting plate 3, where the thickness of the substrate 1 is t and the height of the protruding portion 7 is d, it is possible to prevent a display failure due to transfer of the mesh pattern, and produce the stable printed results with less variation in the print seal width.

Further, since the gap adjusting plate is attached to contact the stage base, there is no possibility that the height difference between the substrate and the upper surface of the stage is varied. Therefore, even when the process is continuously performed, the proper printing conditions are not changed, so that the stable printed results can be obtained. Also, even if the thickness of substrate is changed, the gap adjusting plate with a predetermined thickness correspondingly prepared is attached to contact the stage base, whereby the stable printed results can be obtained every time with excellent reproducibility under the proper printing conditions.

In the embodiment 1 as described above, the screen printing apparatus can perform the printing under the optimal printing conditions by providing the height adjusting member for adjusting the height relationship between the upper surface of the stage and the main plane of the substrate corresponding to the thickness of the substrate to be treated. Further, since the height adjusting member overhanging out of the main plane of the substrate is attached on both sides of the substrate in the running direction of the squeegee, it is possible to obtain the screen printing apparatus that can manufacture the liquid crystal panel without causing display failure due to transfer of the mesh pattern of the screen mask, and with less variation in the width of the seal pattern, when used in the manufacturing process for the liquid crystal panel. Also, since the height adjusting member is attached to contact the stage base, the height difference between the main plane of the substrate and the upper surface of the stage does not change, whereby it is possible to prevent stably variation in the seal width or occurrence of the display failure.

### Embodiment 2

In the screen printing apparatus according to the embodiment 1, for the stage 2, the stage base 2a provided with the protruding portion 7 and the gap adjusting plate 3 are fitted together. Herein, a second exemplary embodiment (embodiment 2) in which the stage base is not provided with the protruding portion and the gap adjusting plate is relatively thin will be described below.

The embodiment 2 is different from the embodiment 1 only in the structure of the stage base 2a and the gap adjusting plate 3 for the stage 2, but is the same in the printing operation and the other structure as the embodiment 1, except for this change, and the detailed description of the embodiment 2 is omitted.

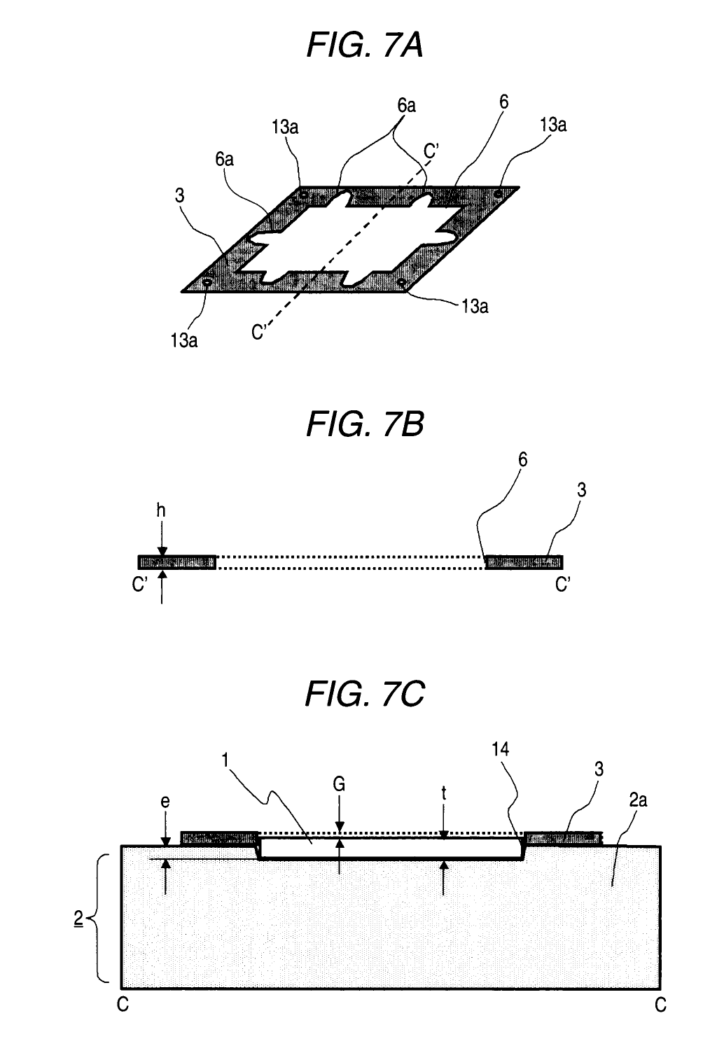

First of all, the constitution of the screen printing apparatus according to the embodiment 2 will be described below, using FIG. 6 that is a perspective view of the stage and FIG. 7 that is an explanatory view for the gap adjusting plate and its mounted state.

The stage 2 holding the substrate 1 constituting this screen printing apparatus, as in the embodiment 1, comprises the stage base 2a, the gap adjusting plate 3, attached on the stage base 2a, acting as a height adjusting member for adjusting the relationship between the upper surface of the stage 2 and the height of the main plane of the substrate 1, a fixing screw 13 for fixing the gap adjusting plate 3 on the stage base 2a on the periphery of the gap adjusting plate 3, the alignment mechanisms 4a and 4b for positioning the substrate 1, and the conveying rollers 5a and 5aa (conveying roller 5aa, not shown, having the same structure as the conveying roller 5a and disposed under the substrate 1 in the figure) for conveying the substrate 1 to the position where it can be positioned on the stage, as shown in FIG. 6. Also, the conveying rollers 5b and 5c for conveying the substrate onto or out of the stage 2 are disposed before and after the stage 2.

FIG. 7A is a perspective view of the gap adjusting plate 3, which is formed with the mortise portion 6 corresponding to the shape of the substrate and a mounting hole 13a corresponding to the position of the fixing screw 13 on the periphery. Also, the gap adjusting plate 3 is formed with the mortise portion 6a corresponding to the operation range of the alignment mechanisms 4a and 4b, as needed. FIG. 7B is a cross-sectional view of the gap adjusting plate 3, taken along the line C′-C′ in FIG. 7A. The gap adjusting plate 3 is like a thin plate having the thickness h.

FIG. 7C is a cross-sectional view showing a mounted state of the gap adjusting plate 3, taken along the line C-C in FIG. 6. From FIG. 7C, the stage base 2a is formed with a dig portion 14 corresponding to the shape of the substrate 1 to receive the substrate 1. Further, the gap adjusting plate 3 is formed with the mortise portion 6 corresponding to the shape of the substrate so as to correspond to the position of the substrate 1. The thickness of the gap adjusting plate 3 is selected so that the upper surface of the stage 2 may overhang out of the main plane of the substrate 1, namely, the height difference G=e+h−t between the surface of the gap adjusting plate 3 and the upper surface of the substrate 1 may be positive, where the thickness of the gap adjusting plate 3 is h, the depth of the dig portion 14 is e and the thickness of the substrate is t.

In this embodiment 2, since the gap adjusting plate 3 acts to supplement the depth of the dig portion 14 provided in the stage base 2a so that the height difference G may be at least positive, it is applicable to not only the case where the dig portion 14 is provided but also the case where the depth of the dig portion 14 is zero, namely, the stage base 2a is flat, achieving the same effects as in the embodiment 2.

Also, the upper surface of the stage 2 overhangs out of the main plane of the substrate 1, namely, the height difference G between the surface of the gap adjusting plate 3 and the upper surface of the substrate 1 is positive, as described in the embodiment 1. Further, as the value of G is increased, the display failure is less likely to occur due to transfer of the mesh pattern of the screen mask. The height is selected to satisfy 0.1 mm≦G≦0.2 mm, namely, 0.1 mm≦e+h−t≦0.2 mm because the height difference G is represented as G=e+h−t, where the thickness of the substrate 1 is t, the depth of the dig portion 14 is e and the thickness of the gap adjusting plate 3 is h. Thereby, the stable printed results with less variation in the seal width can be obtained. The different gap adjusting plates 3 corresponding to the thickness of the substrate 1 to be treated are prepared, and properly exchanged for use depending on the kind of the substrate 1, whereby the printing can be easily performed under the proper conditions, as in the embodiment 1.

In the embodiment 2, unlike the embodiment 1, the gap adjusting plate 3 does not cover all the surface of the stage base 2a, but only covers the periphery of the substrate 1. However, because the effect of adjusting the height having an influence during printing actually occurs with the gap adjusting plate 3 in an area on which the squeegee rides up, the same effects as the embodiment 1 can be obtained if the gap adjusting plate 3 is disposed at least in the area on which the squeegee rides up during printing on both sides of the substrate 1. Also, the gap adjusting plate 3 of the embodiment 2, which is thinner and has smaller strength than the embodiment 1, is made the necessary minimum size, whereby it is possible to prevent breakage during exchange or storage.

Also, in the embodiment 2, the stage base 2a has no special shape, unlike the embodiment 1 of which the structure is provided with the protruding portion, and can be applied to the ordinary screen printing apparatus, whereby the same effects can be achieved by attaching the appropriate gap adjusting plate 3 on the stage of the ordinary screen printing apparatus. Further, the securing means of the gap adjusting plate 3 is not limited to the fixing screw 13, but may be a double-faced tape between the stage base 2a and the gap adjusting plate 3 to secure the gap adjusting plate 3, or a tape that is bonded to the stage base 2a over the end portion of the gap adjusting plate 3. In this case, the overhang amount from the main plane of the substrate 1 is adjusted depending on the thickness of the gap adjusting plate 3 including the thickness of the tape, or the tape is bonded not to stretch over the area of the gap adjusting plate 3 on which the squeegee rides up. Also, since the stage base 2a is typically made of a material such as stainless attracted by a magneto, the gap adjusting plate 3 may be formed of a magneto material to bond and secure it by the magneto. These methods can be applied to the ordinary screen printing apparatus, thereby achieving the same effects.

In the embodiment 2 as described above, like the embodiment 1, the screen printing apparatus can perform the printing under the optimal printing conditions by providing the height adjusting member for adjusting the height relationship between the upper surface of the stage and the main plane of the substrate corresponding to the thickness of the substrate to be treated. Further, since the height adjusting member overhanging out of the main plane of the substrate is attached on both sides of the substrate in the running direction of the squeegee, it is possible to obtain the screen printing apparatus that can manufacture the liquid crystal panel without causing display failure due to transfer of the mesh pattern of the screen mask, and with less variation in the width of the seal pattern, when used in the manufacturing process for the liquid crystal panel. Also, since the height adjusting member is fixed on the stage base, the height difference between the main plane of the substrate and the upper surface of the stage does not change, whereby it is possible to prevent stably variation in the seal width or occurrence of the display failure.

### Embodiment 3

To constitute the stage 2 in a state where the upper surface overhangs out of the main plane of the substrate 1 by attaching the gap adjusting plate 3 on the stage base 2a, several modifications can be considered by modifying the shapes of the stage base 2a and the gap adjusting plate 3. These modifications will be described below in a third exemplary embodiment (embodiment 3).

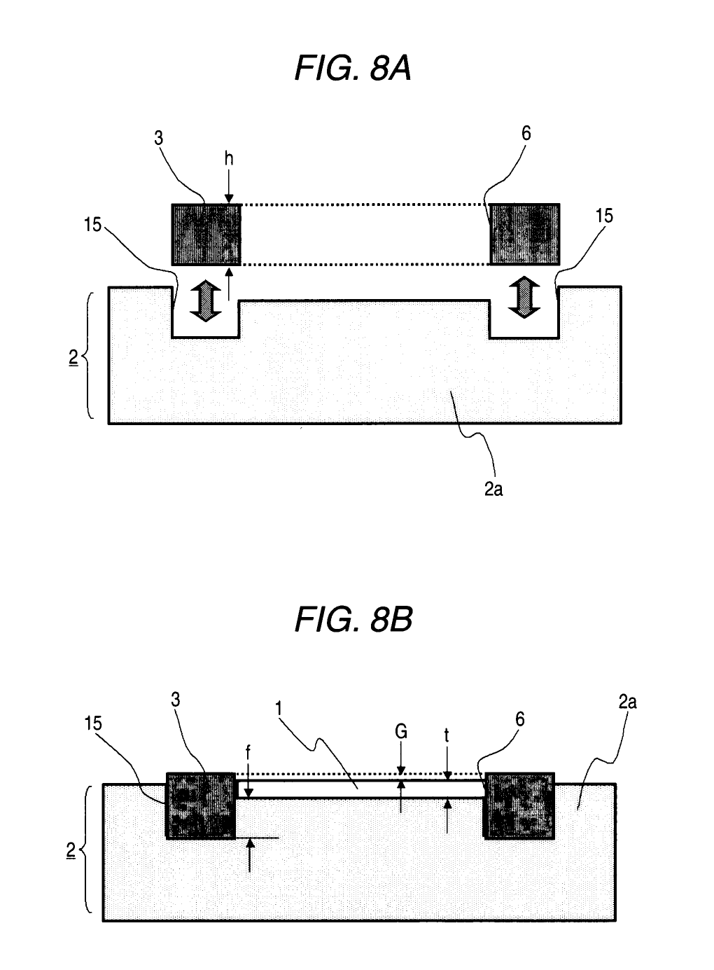

First of all, the screen printing apparatus in a first modification will be described below using a cross-sectional view of FIG. 8. An overall view of the screen printing apparatus is the same as described in the embodiment 2, except for the fixing screw 13 as shown in FIG. 6 is omitted.

In the first modification, the screen printing apparatus comprises the annular gap adjusting plate 3 that has slightly greater thickness h and formed with the mortise portion 6 corresponding to the shape of the substrate 1, and the stage base 2a formed with a dig portion 15 as shown in FIG. 8A, as compared with FIG. 7 as described in the embodiment 2. The gap adjusting plate 3 is fitted with the dig portion 15 of the stage base 2a as shown in FIG. 8B, and attached or detached as indicated by the arrow in FIG. 8A.

The thickness of the gap adjusting plate 3 is selected such that the upper surface of the stage 2 may overhang out of the main plane of the substrate 1, namely, the height difference G=h−f−t between the surface of the gap adjusting plate 3 and the upper surface of the substrate 1 may be positive, where the thickness of the gap adjusting plate 3 is h, the depth of the dig portion 15 from the surface holding the substrate 1 is f, and the thickness of the substrate 1 is t, in a state where the gap adjusting plate 3 is attached on the stage base 2a as shown in FIG. 8B.

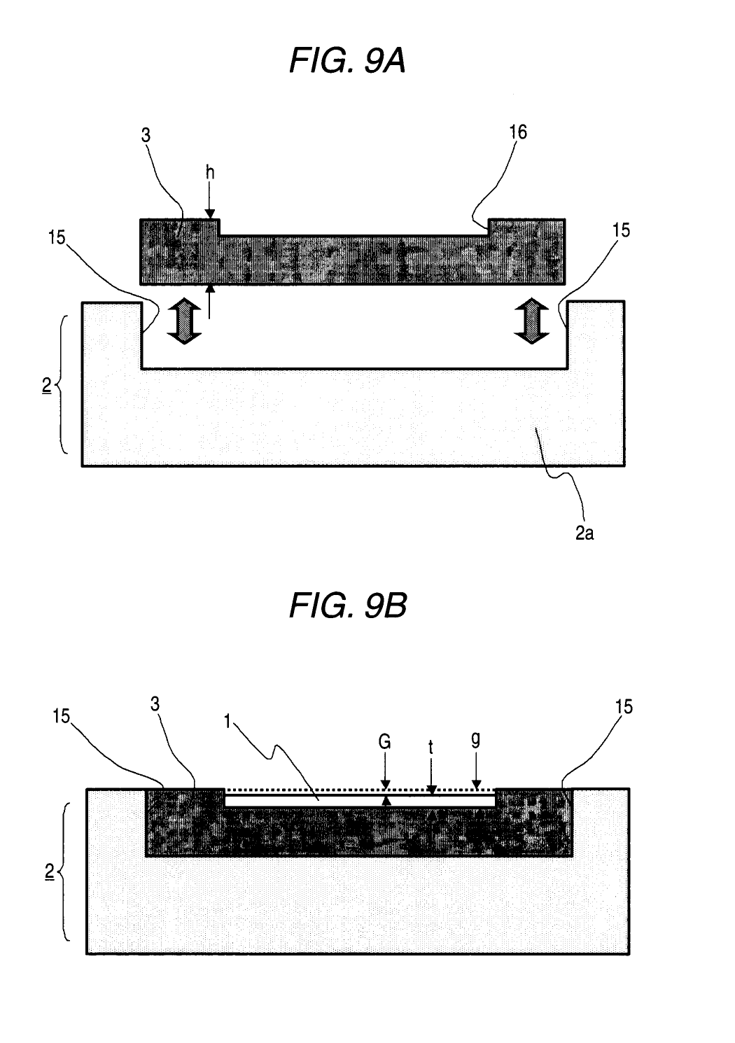

Also, in the modification 1, since it is necessary that the gap adjusting plate 3 is disposed at least in the area where the squeegee rides up during printing on both sides of the substrate 1, as described in the embodiment 2, the area on which the squeegee rides up may be only a part of the annular gap adjusting plate 3. That is, two gap adjusting plates 3R and 3L of rectangular parallelepiped may be disposed on both sides of the substrate 1 in the motion direction of the squeegee. Subsequently, the screen printing apparatus in a second modification will be described below using a cross-sectional view of FIG. 9. In the second modification, the stage 2 comprises the gap adjusting plate 3 formed with a dig portion 16 corresponding to the shape of substrate and the stage base 2a formed with the dig portion 15, as shown in FIG. 9A. The gap adjusting plate 3 can be fitted with the dig portion 15 of the stage base 2a as shown in FIG. 9B, and attached or detached as indicated by the arrow in FIG. 9A.

Also, the depth G of the dig portion 16 of the gap adjusting plate 3 is selected such that the upper surface of the stage 2 may overhang out of the main plane of the substrate 1, namely, the height difference G=g−t between the surface of the gap adjusting plate 3 and the upper surface of the substrate 1 may be positive, where the thickness of the gap adjusting plate 3 is h, the depth of the dig portion 16 receiving the substrate 1 is g, and the thickness of the substrate 1 is t, in a state where the gap adjusting plate 3 is attached on the stage base 2a as shown in FIG. 9B.

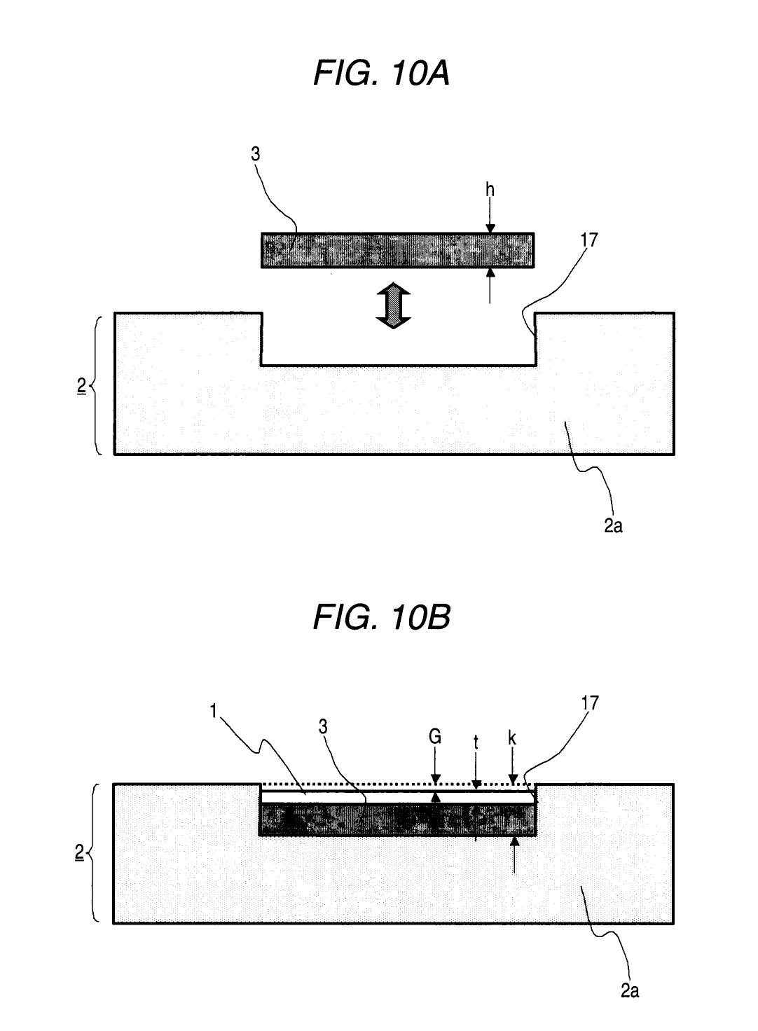

Subsequently, the screen printing apparatus in a third modification will be described below using a cross-sectional view of FIG. 10. In the third modification, the stage 2 comprises the gap adjusting plate 3 corresponding to the shape of substrate and having a plate shape, and the stage base 2a formed with a dig portion 17 corresponding to the shape of substrate, as shown in FIG. 10A. The gap adjusting plate 3 is fitted with the dig portion 17 of the stage base 2a as shown in FIG. 10B, and attached or detached as indicated by the arrow in FIG. 9A.

Also, the depth G of the dig portion 17 of the gap adjusting plate 3 is selected such that the upper surface of the stage 2 may overhang out of the main plane of the substrate 1, namely, the height difference G=k−h−t between the surface of the gap adjusting plate 3 and the upper surface of the substrate 1 may be positive, where the thickness of the gap adjusting plate 3 is h, the depth of the dig portion 17 in the shape of substrate is k, and the thickness of the substrate 1 is t, in a state where the gap adjusting plate 3 is attached on the stage base 2a as shown in FIG. 10B.

In the modifications 1 to 3 as described above, the stable printed results with less variation in the seal width can be obtained by selecting the gap adjusting plate 3 corresponding to the thickness of the substrate 1 such that 0.1 mm≦G≦0.2 mm as in the embodiment 1.

Since the gap adjusting plate 3 has certain thickness and weight and is fitted with the stage base 2a and attached as in the embodiment 1, the printing is performed at high accuracy especially without using the screw for fastening.

Also, the gap adjusting plate 3 of the necessary minimum size can be compact and lightweight as in the embodiment 2, whereby the gap adjusting plate is easily carried during exchange, and stored in a relatively small space during storage.

In the embodiment 3 as described above, like the embodiment 1, the screen printing apparatus can perform the printing under the optimal printing conditions by providing the height adjusting member for adjusting the height relationship between the upper surface of the stage and the main plane of the substrate corresponding to the thickness of the substrate to be treated. Further, since the height adjusting member is attached so that the upper surface of the stage may overhang out of the main plane of the substrate on both sides of the substrate in the running direction of the squeegee, it is possible to obtain the screen printing apparatus that can manufacture the liquid crystal panel without causing display failure due to transfer of the mesh pattern of the screen mask, and with less variation in the width of the seal pattern, when used in the manufacturing process for the liquid crystal panel. Also, since the height adjusting member is attached to contact the stage base, the height difference between the main plane of the substrate and the upper surface of the stage does not change, whereby it is possible to prevent stably variation in the seal width or occurrence of the display failure.

### Embodiment 4

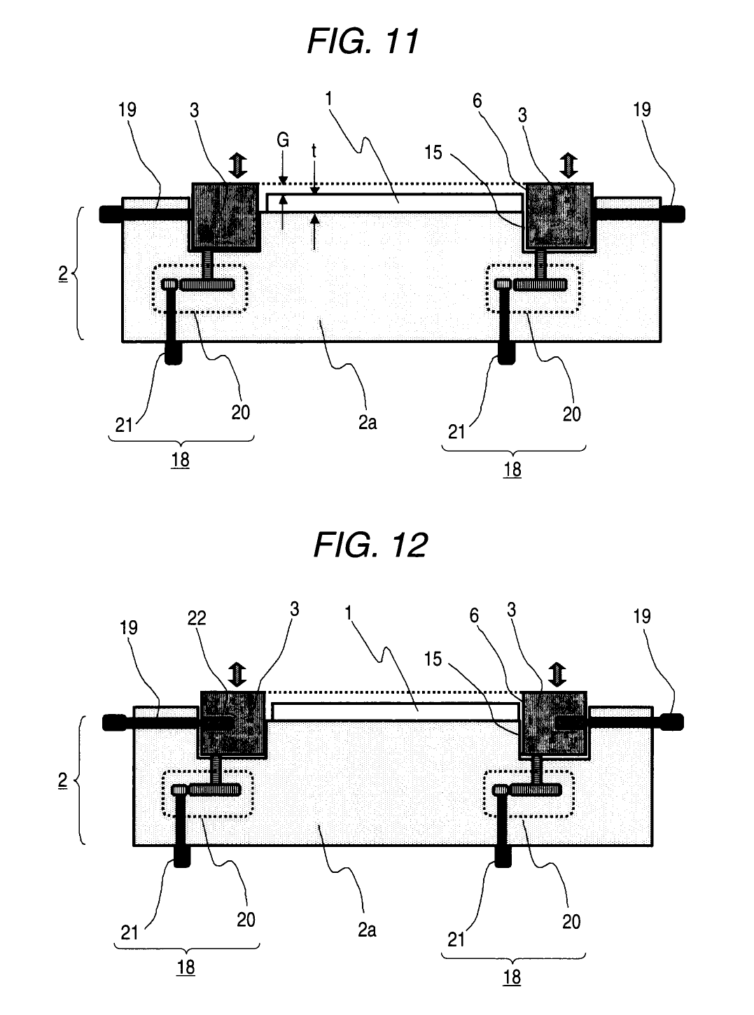

A fourth exemplary embodiment (embodiment 4) in which the stage base 2a comprises a moving mechanism for moving the gap adjusting plate 3 in the screen printing apparatus according to the modification 1 of the embodiment 3 will be described below using a cross-sectional view of FIG. 11.

The embodiment 4 is the same as the modification 1 of the embodiment 3 in that the stage comprises the gap adjusting plate 3 formed with the dig portion 6 corresponding to the shape of the substrate 1 and the stage base 2a formed with the dig portion 15, and the gap adjusting plate 3 is fitted with the dig portion 15 of the stage base 2a and attached, as shown in FIG. 11. However, the embodiment 4 is different from the modification 1 of the embodiment 3 in that the stage base 2a is provided with a moving mechanism 18 for moving up or down the gap adjusting plate 3 as indicated by the arrow in FIG. 11. Further, a fixing screw 19 is provided as securing means for securing the gap adjusting plate 3 to the stage base 2a at the position after travel.

The moving mechanism 18 is composed of a drive gear 20 for driving up or down the gap adjusting plate 3 precisely, and a rotary knob 21 for giving a turning force that is transformed into an up or down motion by the drive gear 20. Also, to estimate a minute amount of travel of the gap adjusting plate 3, the rotary knob 21 has desirably a structure having a scale for estimating the amount of travel such as a micrometer. Also, the fixing screws 19 can be screwed in to hold the gap adjusting plate 3 between them and completely fix it at the position after travel.

Also, the gap adjusting plate 3 is moved by the moving mechanism 18 for adjusting the amount of travel so that the upper surface of the stage 2 may overhang out of the main plane of the substrate 1, namely, the height difference G between the surface of the gap adjusting plate 3 and the upper surface of the substrate 1 may be positive for the substrate 1 having the thickness t, as shown in FIG. 11.

In the embodiment 4 as described above, like the embodiment 1, the gap adjusting plate 3 is moved by the moving mechanism 18 for adjusting the amount of travel for the thickness t of the substrate 1 such that 0.1 mm≦G≦0.2 mm, and further fixed on the stage base 2a at the moved position by the fixing screws 19, whereby the stable printed results with less variation in the seal width can be obtained.

In the embodiment 4 as described above, like the embodiment 1, the screen printing apparatus can perform the printing under the optimal printing conditions by providing the height adjusting member for adjusting the height relationship between the upper surface of the stage and the main plane of the substrate corresponding to the thickness of the substrate to be treated. Further, since the height adjusting member overhanging out of the main plane of the substrate is attached on both sides of the substrate in the running direction of the squeegee, it is possible to obtain the screen printing apparatus that can manufacture the liquid crystal panel without causing display failure due to transfer of the mesh pattern of the screen mask, and with less variation in the width of the seal pattern, when used in the manufacturing process for the liquid crystal panel. Also, since the height adjusting member is fixed on the stage base, the height difference between the main plane of the substrate and the upper surface of the stage does not change, whereby it is possible to prevent stably variation in the seal width or occurrence of the display failure.

### Embodiment 5

Next, a fifth exemplary embodiment (embodiment 5) with a modified method for fixing the gap adjusting plate 3 on the stage base 2a in the screen printing apparatus according to the modification 1 of the embodiment 4 will be described below using the explanatory views of FIGS. 12 to 14.

In the embodiment 5, like the embodiment 4, the stage comprises the gap adjusting plate 3 formed with the dig portion 6 corresponding to the shape of the substrate 1 and the stage base 2a formed with the dig portion 15, and the gap adjusting plate 3 is fitted and attached with the dig portion 15 of the stage base 2a, as shown in a cross-sectional view of FIG. 12. The stage base 2a is provided with the moving mechanism 18 for moving up or down the gap adjusting plate 3 as indicated by the arrow in FIG. 12, and provided with the fixing screw 19 that is securing means for securing the gap adjusting plate 3. A different point from the modification 1 of the embodiment 3 is that a mounting hole 22 is provided on the side face of the gap adjusting plate 3 corresponding to the fixing screw 19. The gap adjusting plate 3 can be fixed on the stage base 2a by inserting the fixing screw 19 into the mounting hole 22.

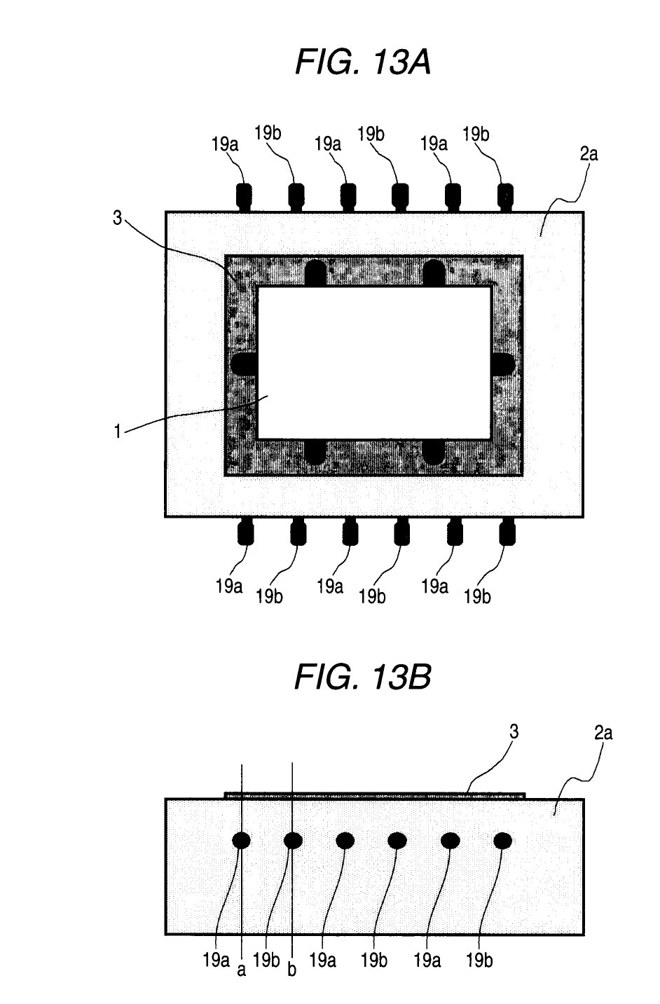

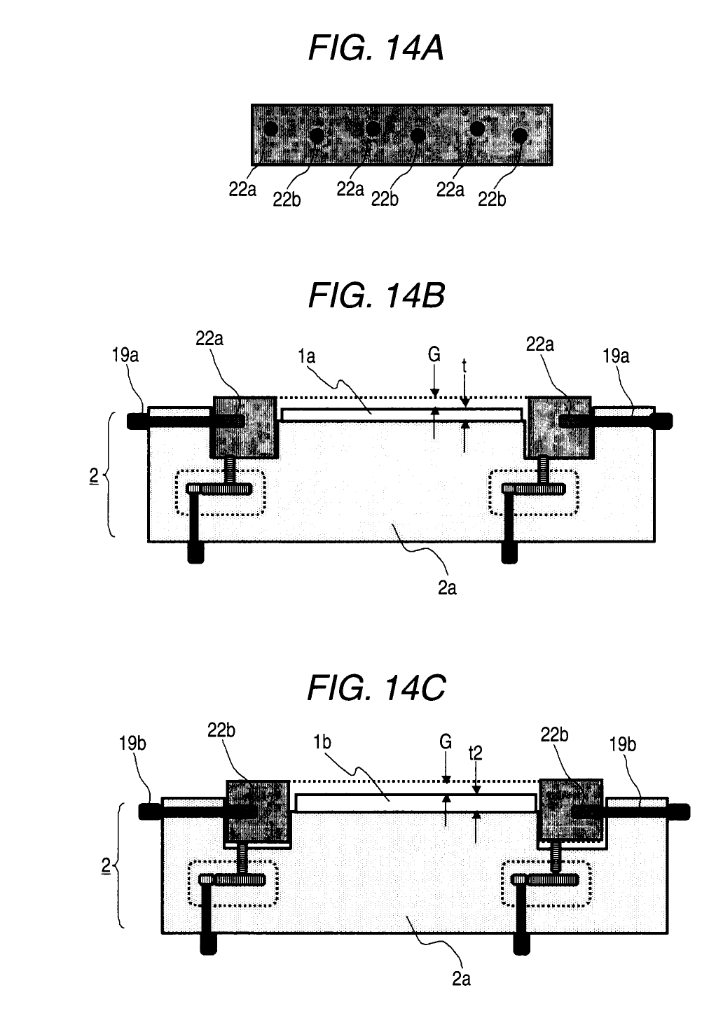

The mounting hole 22 and the fixing screw 19 may be provided in plural sets for fixture at different positions so that the height of the gap adjusting plate 3 may be changed corresponding to the thickness of the different substrate 1, whereby the optimal conditions for several kinds of the substrate can be coped with out exchanging one gap adjusting plate 3. This method will be described below in detail using FIGS. 13 and 14.

FIG. 13A is a typical plan view of the screen printing apparatus according to the embodiment 5, as seen from the upper direction in FIG. 12, and FIG. 13B is a typical view as seen from the side face on the hand of the fixing screw in FIG. 13A. From these figures, it can be found that a plurality of fixing screws 19a and 19b are provided on the side face of the stage base 2a.

Also, FIG. 14A is a typical view of the gap adjusting plate 3 as seen from the side face, in which the mounting holes 22a and 22b corresponding to the fixing screws 19a and 19b in FIG. 13B are provided in the gap adjusting plate 3. Also, the mounting holes 22a and 22b in plural sets are provided at different heights, whereas the corresponding fixing screws 19a and 19b provided on the stage base 2a are provided at the same height.

A method of using properly the fixture with the mounting hole 22a and the fixing screw 19a and the fixture with the mounting hole 22b and the fixing screw 19b will be described below, using FIGS. 14B and 14C that are typical cross-sectional views taken along the section lines a and b as indicated by the dotted line in FIG. 13B. FIG. 14B shows a case where the gap adjusting plate is fixed by the mounting hole 22a and the fixing screw 19a, and FIG. 14C shows a case where the gap adjusting plate is fixed by the mounting hole 22b and the fixing screw 19b. Because the mounting hole 22b is provided at the lower position of the gap adjusting plate 3 than the mounting hole 22a, when the fixture with the mounting hole 22b is selected as shown in FIG. 14C, the gap adjusting plate 3 can be fixed at the higher position on the fixing stage base 2a than the fixture with the mounting hole 22a in FIG. 14B.

In this manner, the gap adjusting plate can be fixed at two different heights by using properly the fixture with the mounting hole 22a and the fixing screw 19a and the fixture with the mounting hole 22b and the fixing screw 19b. For example, in FIG. 14B, for a substrate 1a having a relatively small thickness t1, the positional relationship between the mounting hole 22a and the fixing screw 19a is decided so that the upper surface of the stage 2 may overhang out of the main plane of the substrate 1a, namely, the height difference G between the surface of the gap adjusting plate 3 and the upper surface of the substrate 1 may be positive, while for a substrate 1b having a relatively large thickness t2, the positional relationship between the mounting hole 22b and the fixing screw 19b is decided so that the upper surface of the stage 2 may overhang out of the main plane of the substrate 1b, namely, the height difference G between the surface of the gap adjusting plate 3 and the upper surface of the substrate 1 may be positive, whereby two kinds of substrates 1a and 1b with different thicknesses can be treated under the optimal conditions without exchanging the gap adjusting plate 3.

In the embodiment 5 as described above, like the embodiment 1, the gap adjusting plate 3 is moved by the moving mechanism 18 for adjusting the amount of travel corresponding to the thickness t of the substrate 1 such that 0.1 mm≦G≦0.2 mm, and further fixed on the stage base 2a at the moved position by the fixing screw 19, whereby the stable printed results with less variation in the seal width can be obtained.

Though two kinds of substrates with different thicknesses are treated as described above in the embodiment 5, three or more kinds of substrates can be dealt with by further providing the mounting hole 22 and the fixing screw 19 for fixation at further different height. Further, in the embodiment 5, the height of the fixing screw 19 provided on the stage base 2a is the same, but the height of the mounting hole 22 provided in the gap adjusting plate 3 is changed. Though the gap adjusting plate 3 can be exchanged relatively easily to treat the substrates with different thicknesses, it is also possible that the height of the mounting hole 22 is the same but the height of the fixing screw 19 is changed, whereby the printing can be performed under the optimal conditions for the substrates having different thicknesses, as in the embodiment 5.

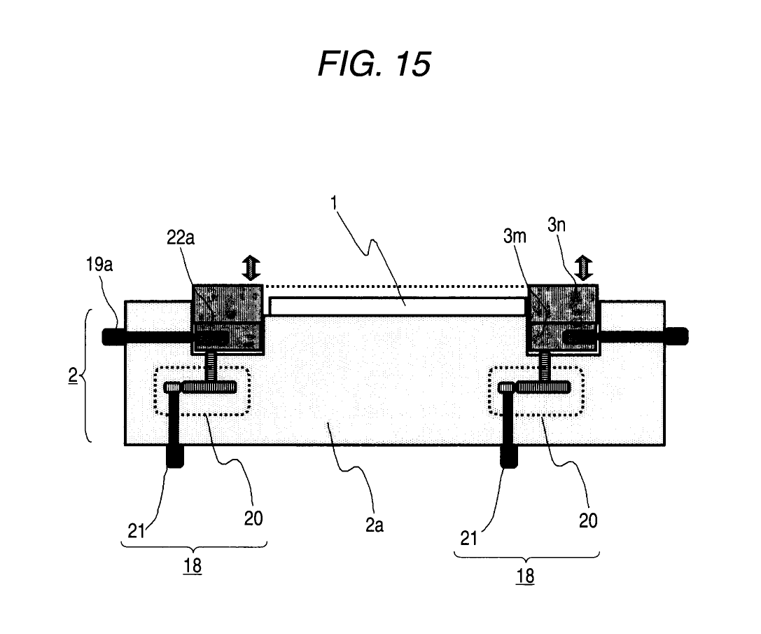

As a modification of the embodiment 5, the gap adjusting plate 3 that is a height adjusting member in the embodiment 5 may be divided into a gap adjusting plate 3m and a gap adjusting plate 3n as shown in FIG. 15. The gap adjusting plate 3m is movable up or down by the same moving mechanism 18 as in the embodiment 5, and can be fixed through the mounting hole 22 provided in the gap adjusting plate 3m. Thereby, the printing can be performed under the optimal conditions corresponding to plural kinds of substrates 1 with different thicknesses as in the embodiment 5. Further, the gap adjusting plate 3n having a different thickness is prepared, and properly used, whereby various kinds of substrates 1 with different thicknesses can be treated. In this modification, only the gap adjusting plate 3n can be exchanged without detaching the gap adjusting plate 3m, whereby the substrates 1 with different thicknesses can be easily treated by changing it.

In the embodiment 5 as described above, like the embodiment 1, the screen printing apparatus can perform the printing under the optimal printing conditions by providing the height adjusting member for adjusting the height relationship between the upper surface of the stage and the main plane of the substrate corresponding to the thickness of the substrate to be treated. Further, since the height adjusting member overhanging out of the main plane of the substrate is fixed on both sides of the substrate in the running direction of the squeegee, it is possible to obtain the screen printing apparatus that can manufacture the liquid crystal panel without causing display failure due to transfer of the mesh pattern of the screen mask, and with less variation in the width of the seal pattern, when used in the manufacturing process for the liquid crystal panel. Also, since the height adjusting member is fixed on the stage base, the height difference between the main plane of the substrate and the upper surface of the stage does not change, whereby it is possible to prevent stably variation in the seal width or occurrence of the display failure.

### Embodiment 6

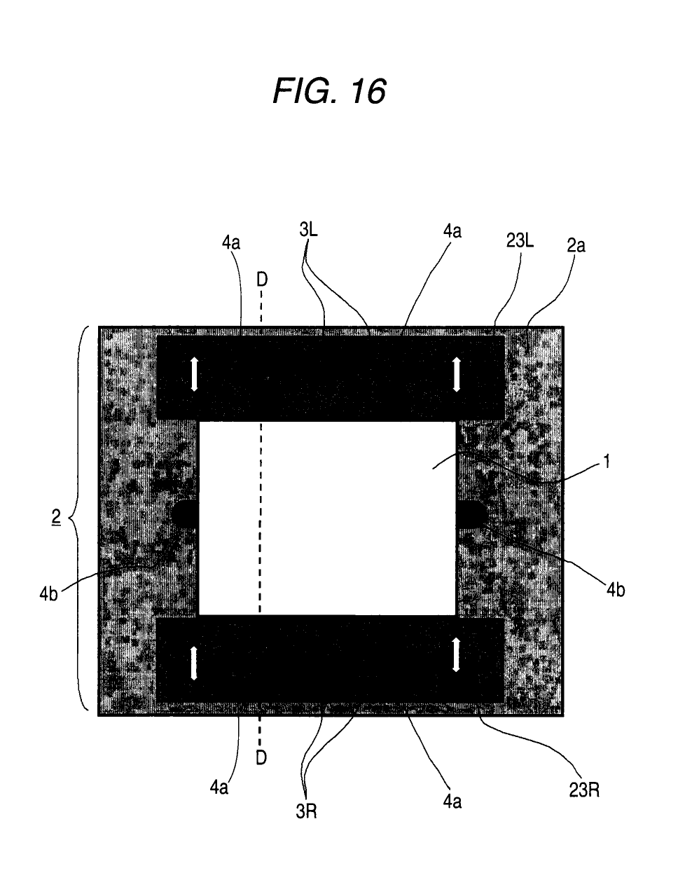

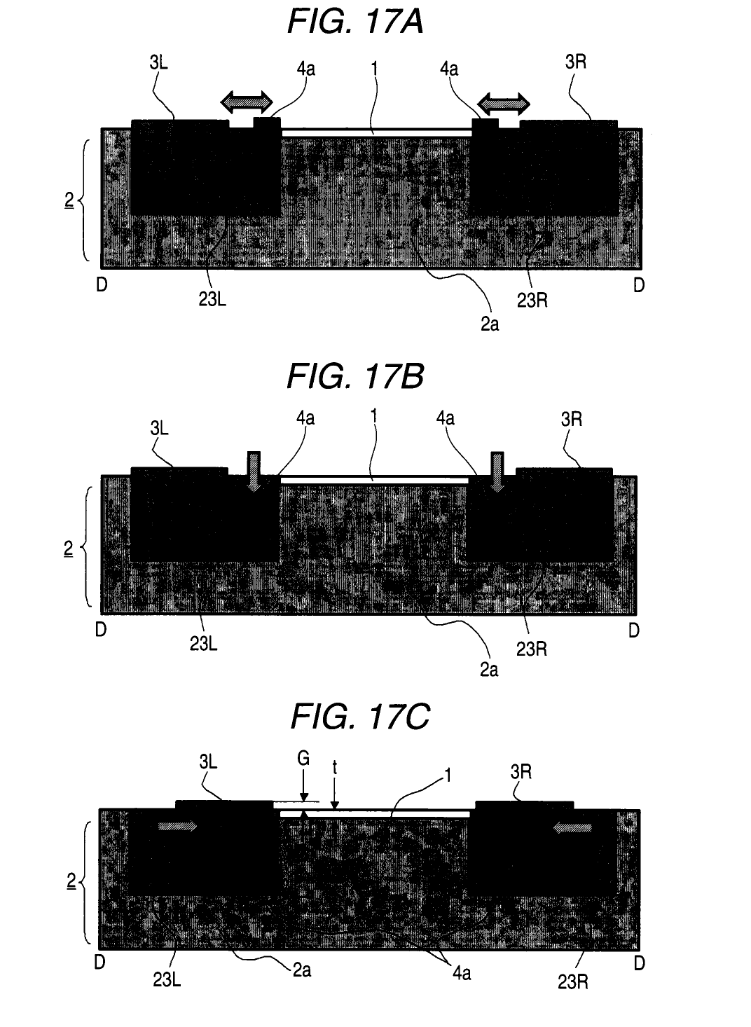

Next, the screen printing apparatus according to a sixth exemplary embodiment (embodiment 6) in which the mortise portion corresponding to the operation range of the alignment mechanisms is not provided in the gap adjusting plate in the embodiments 1 and 2 will be described below using FIGS. 16 and 17.

FIG. 16 is a typical plan view of the screen printing apparatus according to the embodiment 6, as seen from the upper direction of the stage. In the screen printing apparatus according to the embodiment 6, the stage 2 for holding the substrate 1 comprises a stage base 2a, the gap adjusting plates 3R and 3L composed of two rectangular parallelepiped disposed on both sides of the substrate 1 attached on the stage base 2a in the operation direction of the squeegee, a dig portion 23 formed in the stage base 2a for receiving the gap adjusting plates 3R and 3L in the stage base 2a, and the alignment mechanisms 4a and 4b for positioning the substrate 1, as shown in FIG. 16, in which the gap adjusting plates 3R and 3L are retracted during the positioning operation of the alignment mechanisms 4a and 4b. In FIG. 16, the retracted position is indicated by the solid line, and the position in which the gap adjusting plates are disposed on both sides of the substrate 1 is indicated by the dotted line. Also, the conveying roller for conveying the substrate 1 is the same as in the embodiment 1, and its illustration and description are omitted.

The operation from the positioning operation into a preprinting state will be described below, using FIG. 17 that is a cross-sectional view taken along the section line D-D in FIG. 16.

The alignment mechanism 4a performs the positioning operation of the substrate 1 through the opening or closing operation in the direction of the arrow in the figure, as shown in FIG. 17A. At this time, the gap adjusting plates 3R and 3L are retracted to the outside positions of the stage 2 within the dig portions 23R and 23L not to obstruct the positioning operation of the alignment mechanism 4a.

When the positioning of the substrate 1 is completed, the alignment mechanism 4a is retracted in the direction of the arrow in the figure, namely, toward the lower part of the stage base 2a, as shown in FIG. 17B. Subsequently, the gap adjusting plates 3R and 3L that are retracted not to obstruct the positioning operation of the alignment mechanism 4a are moved in the direction of the arrow in the figure, namely, to be disposed on both sides of the substrate 1 in the operation direction of the squeegee as shown in FIG. 17C, so that the stage 2 is placed in a state during printing.

Also, during printing, the thickness of the gap adjusting plates 3L and 3R and the depth of the dig portions 23R and 23L provided in the stage base 2a are designed beforehand so that the upper surface of the stage 2 may overhang out of the main plane of the substrate 1, namely, the height difference G between the surface of the gap adjusting plates 3L and 3R and the upper surface of the substrate 1 may be positive for the substrate 1 having the thickness t, as shown in FIG. 11.

In the embodiment 6 as described above, like the embodiment 1, the thickness of the gap adjusting plates 3L and 3R and the depth of the dig portions 23R and 23L provided in the stage base 2a are designed beforehand such that 0.1 mm≦G≦0.2 mm, corresponding to the thickness t of the substrate 1, whereby the stable printed results with less variation in the seal width can be obtained.

Since the gap adjusting plates 3L and 3R in the embodiment 6 are retracted during the positioning operation, it is unnecessary to form the mortise portion corresponding to the operation range of the alignment mechanisms 4a and 4b. Therefore, the squeegee can perform the printing at constant speed and pressure without being affected by the mortise portion corresponding to the alignment mechanisms during printing, whereby the display failure is less likely to occur due to transfer of the mesh pattern.

In the embodiment 6 as described above, like the embodiment 1, the screen printing apparatus can perform the printing under the optimal printing conditions by providing the height adjusting member for adjusting the height relationship between the upper surface of the stage and the main plane of the substrate corresponding to the thickness of the substrate to be treated. Further, since the height adjusting member overhanging out of the main plane of the substrate is attached on both sides of the substrate in the running direction of the squeegee, it is possible to obtain the screen printing apparatus that can manufacture the liquid crystal panel without causing display failure due to transfer of the mesh pattern of the screen mask, and with less variation in the width of the seal pattern, when used in the manufacturing process for the liquid crystal panel. Also, since the height adjusting member is attached to contact the stage base, the height difference between the main plane of the substrate and the upper surface of the stage does not change, whereby it is possible to prevent stably variation in the seal width or occurrence of the display failure.

### Embodiment 7

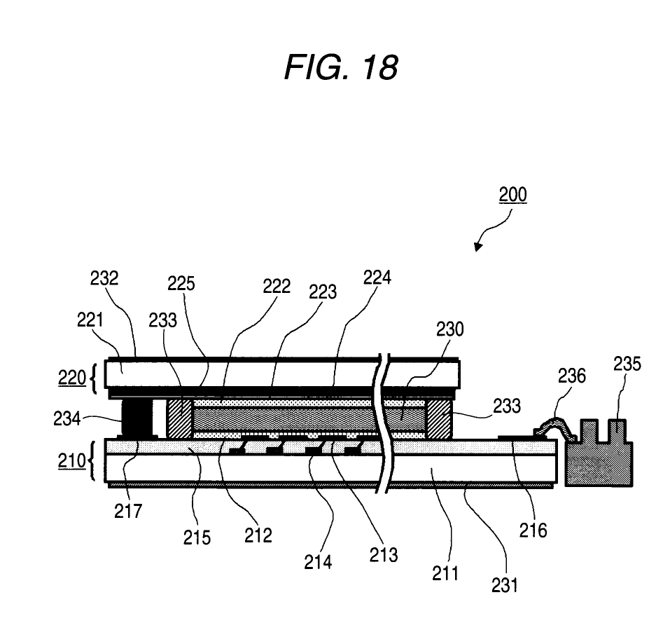

Referring to FIG. 18, the constitution of the liquid crystal panel manufactured according to a seventh exemplary embodiment (embodiment 7) of the invention will be described below. Herein, the liquid crystal panel of a TFT (Thin Film Transistor) type will be described below by way of example. This liquid crystal panel 200 comprises a switching element substrate 210, a color filter substrate 220, a liquid crystal 230 filled between the switching element substrate 210 and the color filter substrate 220, as shown in FIG. 18.

The switching element substrate 210 has an oriented film layer 212 for orienting the liquid crystal 230 on one surface of a glass substrate 211, a pixel electrode 213, provided on the lower part of the oriented film 212, for applying a voltage to drive the liquid crystal 230, a switching element 214 such as a TFT for supplying a voltage to the pixel electrode 213, an insulation film 215 covering the switching element 214, a terminal 216 for accepting a signal supplied from the switching element 214 from the outside, and a transfer electrode 217 for transferring the signal inputted from the terminal 216 to a counter electrode. Also, a polarizer 231 is provided on the other surface of the glass substrate 211.

On the other hand, the color filter substrate 220 has an oriented film 222 for orienting the liquid crystal 230 on one surface of a glass substrate 221, a common electrode 223, disposed on the lower part of the alignment layer 222, for driving the liquid crystal 230 by producing an electric field with the pixel electrode 213 on the switching element substrate 210, and a color filter 224 and a light shield layer 225 provided on the lower part of the common electrode 223. Also, a polarizer 232 is provided on the other surface of the glass substrate 221.

Also, the switching element substrate 210 and the color filter substrate 220 are aligned via a sealing material 233. Further, the transfer electrode 217 and the common electrode 223 are electrically connected by a transfer material 234, so that a signal inputted from the terminal 216 is passed to the common electrode 223. Besides, the liquid crystal panel 200 comprises a control substrate 235 for generating a drive signal, an FPC (Flexible Printed Circuit) 236 for electrically connecting the control substrate 235 to the terminal 216, and a backlight unit (not shown) that becomes a light source.

This liquid crystal panel 200 operates as follows. For example, if an electric signal is inputted from the control substrate 235, a drive voltage is applied to the pixel electrode 213 and the common electrode 223, so that the directions of molecules of the liquid crystal 230 are changed in accordance with the drive voltage. And a light emitted from the backlight unit is transmitted to the outside or shielded via the switching element substrate 210, the liquid crystal 230 and the color filter substrate 220, so that the video is displayed on the liquid crystal panel 200.

This liquid crystal panel 200 is only illustrative, and may take another constitution. The operation mode of the liquid crystal panel 200 may be a TN (Twisted Nematic) mode, an STN (Supper Twisted Nematic) mode, or a ferroelectric liquid crystal mode, and the driving method may be a simple matrix or an active matrix, or a horizontal electric field method in which the common electrode 223 provided on the color filter substrate 220 is placed on the switching element substrate 210 to apply an electric field in the horizontal direction to the pixel electrode 213 on the liquid crystal 230.

A manufacturing method for the liquid crystal panel according to the embodiment 7 will be described below. The manufacturing method for the switching element substrate 210 and the color filter substrate 220 is commonly employed, and will be described simply. The switching element substrate 210 is manufactured by forming the switching element 214, the pixel electrode 213, the terminal 216 and the transfer electrode 217 on one surface of the glass substrate 211 by repeatedly performing a pattern formation process including film formation, patterning by photolithography, and etching. Also, the color filter substrate 220 is similarly manufactured by forming the color filter 224 and the common electrode 223 on one surface of the glass substrate 221.

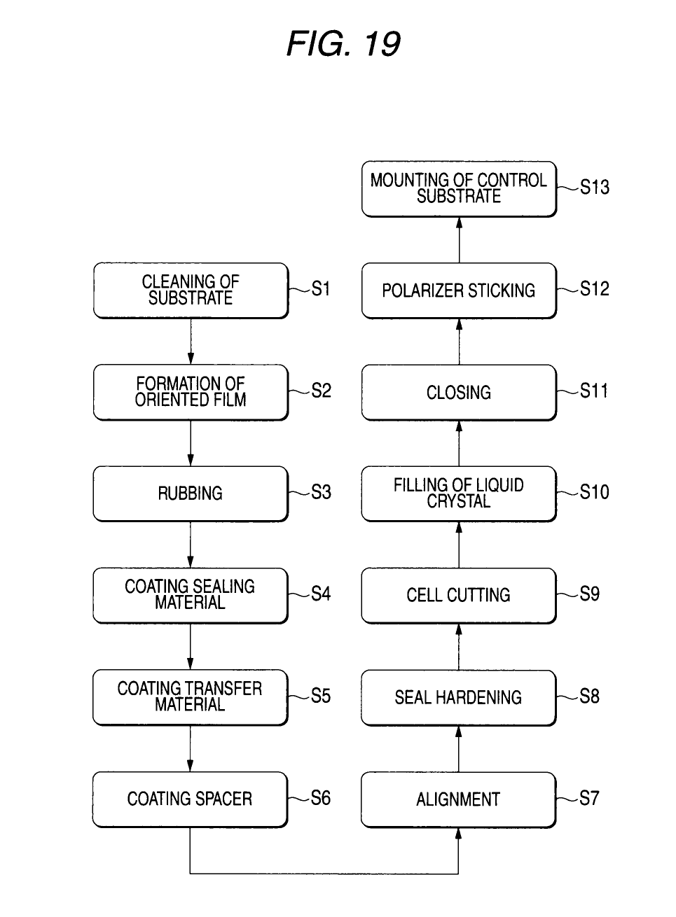

Next, an assembling process that is characteristic in this embodiment 7 will be described below in accordance with a flowchart as shown in FIG. 19. First of all, the switching element substrate 210 formed with the pixel electrode 213 is cleaned in a substrate cleaning process (S1). Next, the oriented film 212 is formed on one surface of the switching element substrate 210 in an oriented film formation process (S2). This process is performing by coating the oriented film 212 composed of an organic film by a printing method, and drying it through a burning process with a hot plate, for example. Thereafter, the oriented film 212 is oriented by rubbing the oriented film 212 in a rubbing process (S3).

Also, the color filter substrate 220 formed with the common electrode 223 is treated through the process of cleaning, forming the oriented film 222 and rubbing in the same manner as at S1 to S3.

Subsequently, a coating process for coating the sealing material 233 on one surface of the switching element substrate 210 or the color filter substrate 220 is performed in a seal coating process, using a seal printing apparatus as described in the embodiment 1 (S4). In this case, the printing was performed using the appropriate height adjusting member corresponding to the thickness of the substrate to be treated. The pressure of a seal plate on the surface of the oriented film 212 or the oriented film 222 is stably moderated during printing by using the seal printing apparatus as described in the embodiment 1. For the sealing material 233, a thermosetting resin or ultraviolet rays hardening resin such as epoxy adhesive was employed.

Next, in a transfer material coating process, a coating process for coating the transfer material 234 on one surface of the switching element substrate 210 or the color filter substrate 220 is performed (S5). And in a spacer spray process, a spacer is sprayed on one surface of the switching element substrate 210 or the color filter substrate 220 (S6). This process is performed by dispersing the spacer by wet or dry method, for example.

Thereafter, the switching element substrate 210 and the color filter substrate 220 are aligned in an alignment process (S7). Subsequently, the sealing material 233 is completely hardened in a state where the switching element substrate 210 and the color filter substrate 220 a realigned in a seal hardening process (S8). This process is performed by applying heat or ultraviolet ray according to the quality of the sealing material 233, for example. Next, the aligned substrates are decomposed into individual cells in a cell cutting process (S9). And a liquid crystal is filled through a liquid crystal filling port in a liquid crystal filling process (S10). This process is performed by filling the liquid crystal 230 through the liquid crystal filling port in vacuum, for example. Further, the liquid crystal filling port is closed in a closing process (S11). This process is performed by closing it with a light hardening resin and applying light, for example.

Each process from alignment to closing of liquid crystal at S7 to S13 has been described taking a liquid crystal filling method through the normal filling port as one example. However, as another liquid crystal filling method, a so-called one drop fill method may be employed in which there is no filling port for the sealing material 233, the liquid crystal 230 is dispensed in a liquid drop state on the switching element substrate 210 or the color filter substrate 220, the switching element substrate 210 and the color filter substrate 220 are aligned to sandwich the dropped liquid crystal 230, and the sealing material 233 is hardened.

Finally, the polarizers 231 and 232 are stuck on the cell in a polarizer sticking process (S12), and the control substrate 235 is mounted in a control substrate mounting process (S13), whereby the liquid crystal panel 200 is completed.

In the liquid crystal panel of the embodiment 7 as described above, the screen printing apparatus having the stage in which the height adjusting member overhanging out of the main plane of the substrate is attached on both sides of the substrate in the running direction of the squeegee is used in the seal coating process for the liquid crystal panel, whereby it is possible to obtain the liquid crystal panel without occurrence of display failure due to transfer of the mesh pattern of the screen mask, and with less variation in the width of the seal pattern. Though the manufacturing method for the liquid crystal display panel using the screen printing apparatus of the embodiment 1 in the seal coating process has been described above in this embodiment 7, the screen printing apparatus as described in the other embodiments 2 to 6 may be used, instead of the screen printing apparatus of the embodiment 1, thereby achieving the same effects as in the embodiment 7.

What is claimed is:

1. A screen printing apparatus comprising:
a screen mask having an opening pattern;
a squeegee for coating a paste disposed on the screen mask to a plane of a substrate disposed on the lower part of the screen mask via the opening pattern; and
a stage for holding the substrate comprising:
a stage base; and
a height adjusting member disposed or attached to the stage base, the height adjusting member adjusting a relationship between a plane composed of a part of the stage and the height of the plane of the substrate.

2. The screen printing apparatus according to claim 1,
wherein the height adjusting member is disposed or attached so as to have a plane composed of a part of the stage overhanging out of the main plane of the substrate on both sides of the substrate in the running direction of the squeegee.

3. The screen printing apparatus according to claim 1,
wherein a protruding portion is formed on the stage base, and the protruding portion includes a convex surface holding the substrate, and
wherein the height adjusting member is annular and formed with a mortise portion corresponding to the substrate, and the height adjusting member is attached on the stage base by fitting the mortise portion with the protruding portion.

4. The screen printing apparatus according to claim 1,
wherein a dig portion fitted with the height adjusting member is formed in the stage base.

5. The screen printing apparatus according to claim 1,
wherein the height adjusting member is a plate corresponding to a shape of the substrate, and a dig portion corresponding to the shape of the substrate is formed in the stage base, and
wherein the height adjusting member and the dig portion formed in the stage base are fitted.

6. The screen printing apparatus according to claim 1,
wherein a dig portion corresponding to the shape of the substrate to receive the substrate is formed in the height adjusting member, and a dig portion fitted with the height adjusting member is formed in the stage base.

7. The screen printing apparatus according to claim 1, further comprising,
a moving mechanism for moving the height adjusting member.

8. The screen printing apparatus according to claim 7, further comprising,
a scale for estimating the amount of travel of the height adjusting member.

9. The screen printing apparatus according to claim 7, further comprising,
a securing unit for securing the height adjusting member at the position after travel.

10. The screen printing apparatus according to claim 9,
wherein the securing unit is a fixture with a fixing screw for fixing the height adjusting member and a mounting hole provided in the stage base.

11. The screen printing apparatus according to claim 10, further comprising,
a plurality of mounting holes for fixation at different positions.

12. The screen printing apparatus according to claim 7,
wherein the travel of the height adjusting member includes retracting to a position not to obstruct the positioning operation of an alignment mechanism for positioning the substrate on the stage and moving to a position where the plane overhanging out of the main plane of the substrate after completion of the positioning operation is provided on each side of the substrate in the running direction of the squeegee.

13. The screen printing apparatus according to claim 2, wherein an amount in which the height adjusting member overhangs relative to the plane of the substrate is from 0.1 to 0.2 mm.

14. A screen printing method for coating a paste disposed on a screen mask via an opening pattern provided on the screen mask to a main plane of a substrate disposed on the lower part of the screen mask by running a squeegee, comprising:
performing the printing on a stage base constituting a stage for holding the substrate in such a way that a height adjusting member, attached to the stage base to constitute the stage, for adjusting the relationship between a plane composed of a part of the stage and the height of the main plane of the substrate corresponding to the thickness of the substrate is secured or attached to overhang 0.1 to 0.2 mm upward of the main plane of the substrate on both sides of the substrate in the running direction of the squeegee.

15. A liquid crystal panel manufactured using the screen printing apparatus according to claim 1.

16. A liquid crystal panel manufactured by the screen printing method according to claim 14.
